(19) United States
(12) Patent Application Publication
(10) Pub. No.: US 2016/0055100 A1
(43) Pub. Date: Feb. 25, 2016

(54) SYSTEM AND METHOD FOR REVERSE INCLUSION IN MULTILEVEL CACHE HIERARCHY

(71) Applicant: Advanced Micro Devices, Inc., Sunnyvale, CA (US)

(72) Inventor: Gabriel H. Loh, Bellevue, WA (US)

(21) Appl. No.: 14/463,647

(22) Filed: Aug. 19, 2014

(51) Int. Cl. G06F 12/12; G06F 12/08

(52) U.S. Cl. CPC G06F 12/128; G06F 12/0833; G06F 12/0811; G06F 2212/283; G06F 2212/69; G06F 2212/62

(57) ABSTRACT

A processing system having multilevel cache employs techniques for identifying and selecting valid candidate cache lines for eviction from a lower level cache of an inclusive cache hierarchy, so as to reduce invalidations resulting from an eviction of a cache line in a lower level cache that also resides in a higher level cache. In response to an eviction trigger for a lower level cache, a cache controller identifies candidate cache lines for eviction from the cache lines residing in the lower level cache based on the replacement policy. The cache controller uses residency metadata to identify the candidate cache line as a valid candidate if it does not also reside in the higher cache and as an invalid candidate if it does reside in the higher cache. The cache controller prevents eviction of invalid candidates, so as to avoid unnecessary invalidations in the higher cache while maintaining inclusiveness.

### BACKGROUND

1. Field of the Disclosure

The present disclosure relates generally to caching in processing systems and more particularly to caching in multilevel cache hierarchies.

2. Description of the Related Art

Processing devices often employ multilevel cache systems to bridge the performance gap between processors and memory. When employing a multilevel cache system, an important design decision is whether to adopt an exclusive scheme or an inclusive scheme. In an exclusive cache hierarchy, a lower level (or outer) cache (e.g., an L2 cache) is prevented from containing any cache lines present in a higher level (or inner) cache (e.g., an L1 cache). The exclusive scheme maximizes cache capacities by avoiding overlap between the higher level and lower level caches. However, a cache access under the exclusive scheme often requires both the higher level and lower level caches to be checked, and if a cache line is evicted from the higher level cache it must be moved to a lower level cache. This extra data movement required may result in increased power consumption and slower performance.

Alternatively, in an inclusive scheme, a lower level cache is required to contain all cache lines present in a higher level cache. Invalidating a cache line in an inclusive cache hierarchy only requires checking the lower level cache for the cache line, since the lower level cache will contain at least all of the cache lines present in the higher level cache. Additionally, in the inclusive hierarchy, the lower level cache is not restricted to using the same size cache lines as the higher level cache, as is the case in the exclusive hierarchy. Thus, an inclusive cache hierarchy is often selected for implementation due to these and other benefits.

However, when a cache line present in both the higher level and lower level caches in an inclusive cache hierarchy is evicted from the lower level cache, its copy must also be invalidated in the higher level cache to maintain inclusiveness. This invalidation of the cache line in the higher level cache may occur while the cache line is still in use or otherwise may result in unnecessary and extra invalidations, cache misses, cache re-fetches, lower performance, and higher power consumption.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system employing a reverse inclusion cache hierarchy in accordance with some embodiments.

FIG. 2 is a flow diagram illustrating a method for implementing a reverse inclusion scheme for the cache hierarchy of the processing system of FIG. 1 in accordance with some embodiments.

FIG. 3 is a bock diagram illustrating an example operation of the method of FIG. 2 applied to an inclusive cache hierarchy in accordance with some embodiments.

### DETAILED DESCRIPTION

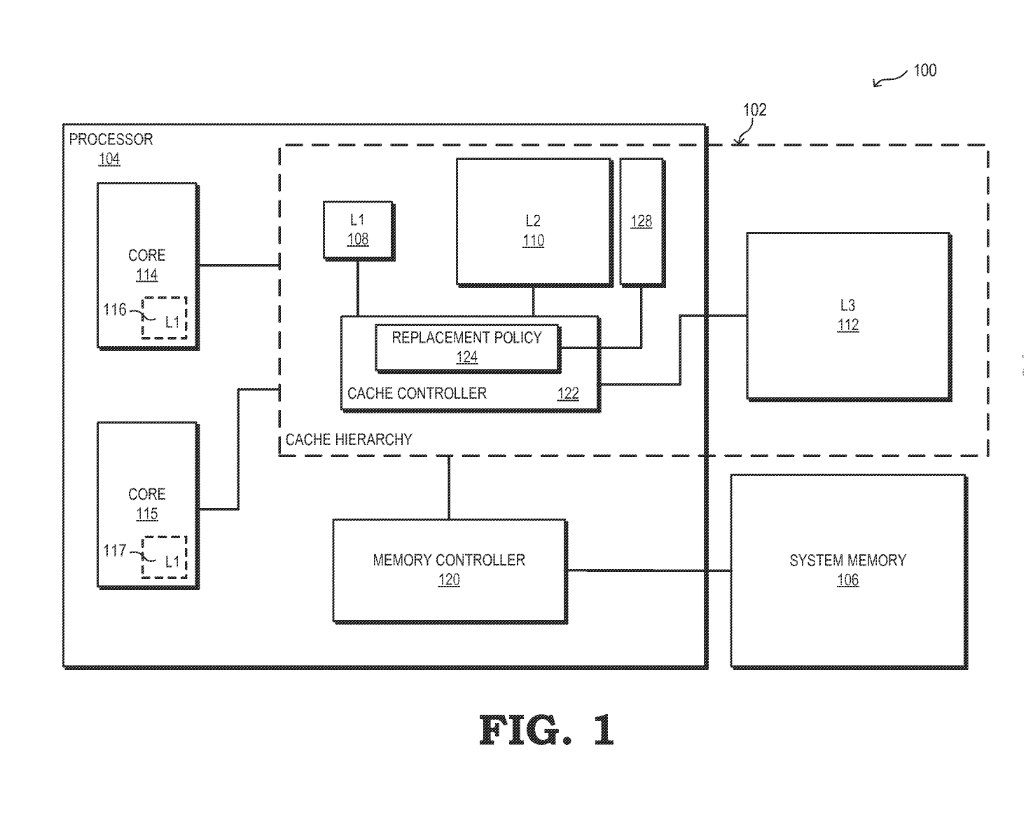

FIGS. 1-3 illustrate example systems and techniques for identifying and selecting valid candidate cache lines for eviction from a lower level cache of an inclusive cache hierarchy, so as to reduce invalidations resulting from an eviction of a cache line in a lower level cache that also resides in a higher level cache. The cache hierarchy has a higher level (or inner) cache (e.g., an L1 cache) and a lower level (or outer) cache (e.g., an L2 cache) and employs an inclusive scheme, such that each cache line residing in the higher level cache must also reside in the lower level cache. When an eviction is triggered for the lower level cache, a cache controller identifies a set of one or more candidate cache lines for eviction from the cache lines residing in the lower level cache based on a replacement policy. For each candidate cache line of the set, the cache controller then determines whether the candidate cache line is valid or invalid based on residency metadata that indicates whether the candidate cache line also resides in the higher level cache. If the candidate cache line also resides in the higher level cache, then it is an invalid candidate, and the cache controller prevents the invalid candidate from being selected for eviction. If, however, the candidate cache line does not reside in the higher level cache, then it is a valid candidate for eviction. The cache controller may perform the validity analysis for one candidate cache line at a time or for the set (or a subset) concurrently. If multiple valid candidate cache lines are identified, the cache controller selects one of the multiple valid candidate cache lines for eviction. These systems and techniques allow for the eviction of a cache line from a lower level cache of an inclusive cache hierarchy while maintaining inclusiveness, and avoiding the unnecessary and extra invalidations, cache misses, cache re-fetches, lower performance, and higher power consumption that may be caused by evicting a cache line from the lower level cache that also resides in the higher level cache.

While the embodiments described herein depict a cache hierarchy having three caches, each cache being of a different level, the techniques discussed herein likewise can be applied to any of a variety of configurations employing a cache hierarchy. Further for ease of illustration, the techniques are described in the example context of an inclusive cache hierarchy, however, the same techniques can be applied to a non-inclusive/non-exclusive cache hierarchy as well, or any other cache hierarchy employing caches that may have copies of the same cache lines at multiple caches of the cache hierarchy. Additionally, while the techniques are primarily described in the context of an L1 cache and an L2 cache, the techniques could similarly be applied between an L2 cache and an L3 cache, an L1 cache and an L3 cache, or the like.

FIG. 1 illustrates a block diagram of a processing system 100 employing a cache hierarchy 102 utilizing a reverse inclusion scheme in accordance with some embodiments. The processing system 100 includes a processor 104, such as a central processing unit (CPU), the cache hierarchy 102, and a system (or “main”) memory 106. The cache hierarchy 102 is illustrated as having three caches 108, 110, 112 of three different levels L1, L2, L3, respectively, with the L1 cache 108 comprising the highest level cache and the L3 cache 112 comprising the lowest level cache in the cache hierarchy 102. Further, as illustrated, the L1 cache 108 is smaller and faster than the L2 cache 110, which is smaller and faster than the L3 cache 112. However, other embodiments may employ any of a variety of cache hierarchies 102. For example, in some embodiments, the cache hierarchy 102 may employ additional or fewer caches. Further, the cache hierarchy 102 of some embodiments may employ additional or fewer cache levels L1, L2, L3. Each of the caches 108, 110, 112 may implement any of a variety of cache structures, for example, direct mapped cache, multi-dimensional set-associative cache, and the like. While the L1 cache 108 and the L2 cache 110 are depicted on-chip (at the processor 104) and the L3 cache 112 is depicted off-chip (not at the processor 104), other embodiments may employ any arrangement of caches, including all on-chip, all off-chip, and the like.

As illustrated, the processor 104 includes one or more processing cores 114, 115 that utilize the cache hierarchy 102 for transient storage of data, instructions, or both. While the cache hierarchy 102 is illustrated as having a single L1 cache 108 shared by the processing cores 114, 115, the described techniques can likewise be applied to cache hierarchies 102 that employ separate L1 caches 116, 117 local to the processing cores 114, 115, respectively. Additionally, the processor 104 of different embodiments may comprise fewer or additional processing cores 114, 115, or fewer or additional local L1 caches 116, 117.

In at least one embodiment, the cache hierarchy 102 is utilized to store data or instructions (hereinafter, collectively “data”) for use by the processor 104 or utilized to facilitate the transfer of data between, for example, processing cores 114, 115 and the system memory 106 through a memory controller 120. While the illustrated embodiment depicts a memory controller 120 implemented at the processor 104, in other embodiments, the memory controller 120 may be implemented elsewhere, for example, at a memory interface of a stacked memory device implementing system memory 106. The memory controller 120 generally allocates data to the system memory 106 from the caches 108, 110, 112, 116, 117 or the processing cores 114, 115, and retrieves data from the system memory 106 for the caches 108, 110, 112, 116, 117 or the processing cores 114, 115.

The processor 104 further comprises cache controller 122, which may be implemented as a unified controller, as several independent (cooperating/coordinated) controllers, as multiple logic modules, or the like, to control each cache 108, 110, 112. For example, the cache controller 122 may control access to each cache 108, 110, 112, control the transfer, insertion, and eviction of data to and from each cache 108, 110, 112 in accordance with one or more replacement policies implemented as replacement policy logic 124, which designates cache behavior related to cache invalidations in accordance with a replacement policy.

In order to insert a new cache line, the replacement policy logic 124 generally tries to predict the cache line least likely to be used in the future, so as to evict the cache line that will result in the most efficient use of the caches 108, 110, 112. If the replacement policy logic 124 predicts poorly, evicting a cache line that is used by the processing core 114, 115 sooner than other cache lines that were candidates for eviction, the processor 104 will likely experience read delays or stalls as a result of having to retrieve the wrongly evicted cache line from the system memory 106 or a lower level cache 108, 110, 112 than necessary. In contrast, if the replacement policy logic 124 predicts correctly, the correctly evicted cache line will not be used by the processing core 114, 115 before the other cache lines that were candidates for eviction, and as such the processor 104 will avoid unnecessary read delays and stalls. The cache controller 122 via the replacement policy logic 124 may employ any of a variety of replacement policies, for example, least recently used (LRU), pseudo-LRU, not recently used (NRU), first in first out (FIFO), least frequently used (LFU), re-reference interval prediction (RRIP), random, a combination of these, and the like. In some embodiments, different replacement policy logic 124 may be used for different caches 108, 110, 112. While the illustrated embodiment depicts unified caches 108, 110, 112, in some embodiments the cache hierarchy 102 may employ a split structure in one or more caches 108, 110, 112, such that instructions and data are cached separately. In these embodiments, the cache controller 122 may employ different replacement policy logic 124 for instruction caches than for data caches.

In the illustrated example, the cache hierarchy 102 implements both an inclusive scheme and a reverse-inclusive scheme. In accordance with the inclusive scheme, all valid cache lines residing in the L1 cache 108 must also have valid copies in the L2 cache 110. Thus, to maintain the inclusiveness of the L2 cache 110, any cache line evicted from the L2 cache 110 must also be evicted from the L1 cache 108. However, when the cache controller 122 evicts a cache line from the L1 cache 108 solely because the cache line was evicted from the L2 cache 110 rather than based on a prediction that the cache line is least likely to be used in the future, the cache controller 122 may be evicting a cache line that a processing core 114, 115 will be requesting soon. In such cases, the eviction of the cache line from the L1 cache 108 is an unnecessary invalidation that may result in cache misses when a processing core 114, 115 requests the cache line, cache re-fetches when the cache line has to be retrieved from a lower level cache (such as the L3 cache 112) or the system memory 106, lower performance of the processing system 100, and higher power consumption by the processing system 100.

In an effort to avoid unnecessary invalidations of cache lines residing in the L1 cache 108 while still maintaining the inclusiveness of the L2 cache 110, the cache hierarchy 102 also employs a reverse inclusion scheme that prevents the replacement policy logic 124 from evicting a cache line from the L2 cache 110 when a valid copy of the cache line is also present in the L1 cache 108. To implement this reverse inclusion scheme, the cache controller 122 may employ a residency storage module 128 to store residency metadata identifying these cache lines of the L2 cache 110 that also reside in the L1 cache 108. For example, the residency metadata may be represented by an array of bits, each bit associated with a corresponding cache line of the L2 cache 110 and programmable to indicate whether the corresponding cache line resides in the L1 cache 108. The replacement policy logic 124 thus can access the residency storage module 128, so as to identify which of the candidate cache lines for eviction from the L2 cache 110 reside in the L1 cache 108 based on the residency metadata.

For example, in an embodiment employing an LRU replacement policy, in response to an eviction trigger for the L2 cache 110, the replacement policy logic 124 identifies as a candidate cache line for eviction, a cache line of the L2 cache 110 that has been accessed least recently relative to the rest of the cache lines residing in the L2 cache 110. The replacement policy logic 124 then determines whether or not the candidate cache line resides in the L1 cache 108 based on the residency metadata stored in the residency storage module 128. If the least recently used candidate cache line does not reside in the L1 cache 108, the replacement policy logic 124 identifies the least recently used candidate cache line as a valid candidate and the cache controller 122 evicts the valid candidate cache line from the L2 cache 110. If, however, the least recently used candidate cache line does reside in the L1 cache 108, the replacement policy logic 124 identifies the least recently used candidate cache line as an invalid candidate in accordance with the reverse inclusion scheme and prevents the cache controller 122 from evicting the invalid candidate cache line from the L2 cache 110, so as to maintain the inclusion property of the L2 cache 110 and avoid unnecessary invalidations of cache lines residing in the L1 cache 108. Following the identification of the least recently used candidate cache line as an invalid candidate, the replacement policy logic 124 determines whether or not the next least recently used candidate cache line resides in the L1 cache 108 based on the residency metadata of the residency storage module 128. The replacement policy logic 124, in some embodiments, continues the validity determination for each candidate cache line in the order designated by the replacement policy (e.g., for LRU, the least recently used, then the second least recently used, then the third recently used, etc.) until the replacement policy logic 124 identifies a valid candidate cache line. That is, once the replacement policy logic 124 identifies a candidate cache line that does not reside in the L1 cache 108, the replacement policy logic 124 identifies the cache line as valid and does not perform the validity determination on further candidate cache lines. The replacement policy logic 124 selects the valid candidate cache line for eviction, and the cache controller 122 evicts the valid candidate cache line from the L2 cache 110, since it does not reside in the L1 cache 108.

Alternatively, in some embodiments, the replacement policy logic 124 performs the validity determination on a set of candidate cache lines concurrently, rather than on each individual candidate cache line until it identifies a valid candidate. That is, for each candidate cache line of the set of candidate cache lines, the replacement policy logic 124 determines whether or not the candidate cache line resides in the L1 cache 108 based on the residency metadata stored in the residency storage module 128. As such, in some embodiments, the replacement policy logic 124 may identify multiple valid candidate cache lines, in which case the valid candidate would still be chosen based on the hierarchy designated by the replacement policy logic 124 (e.g., for an LRU replacement policy, the least recently used valid candidate cache line). In some situations, performing the validity determination on the set of candidate cache lines concurrently, rather than individually, may reduce delay and improve performance of the processing system 100.

While the above examples are described in terms of an LRU replacement policy, the same techniques may be implemented with any of a variety of replacement policies, such as pseudo-LRU, NRU, FIFO, LFU, RRIP, random, a combination of these, and the like. Similarly, although the technique is discussed in terms of the L1 cache 108 and the L2 cache 110 of the processing system 100, the reverse inclusion scheme can similarly be employed between an L2 cache and an L3 cache, between an L1 cache and an L3 cache, or the like.

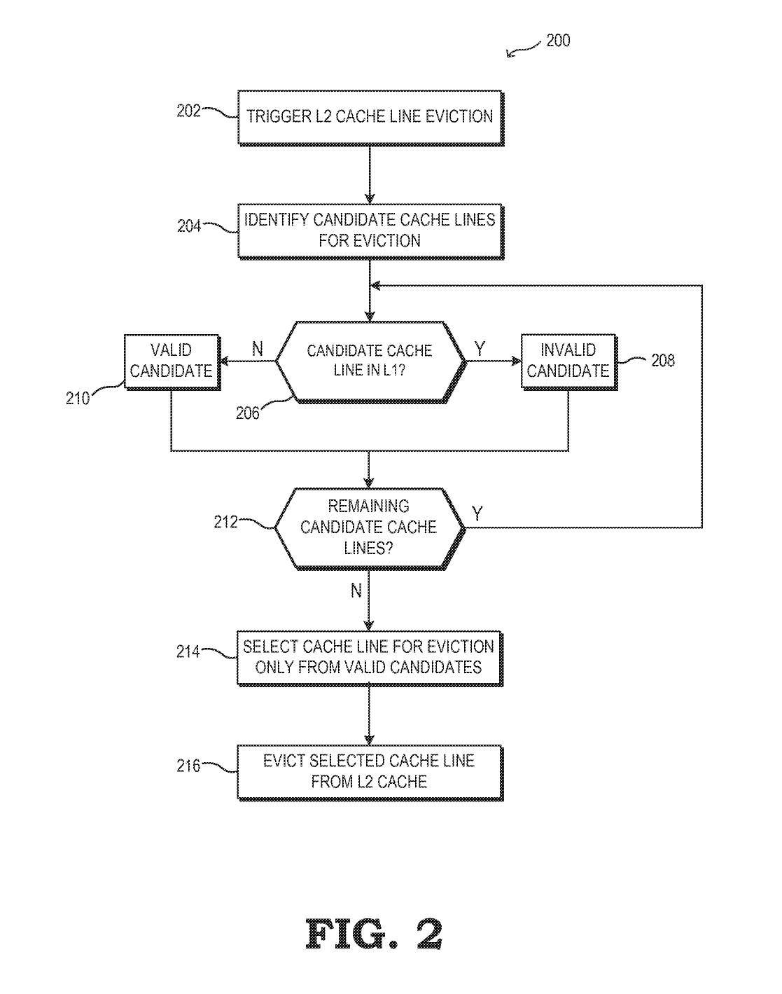

FIG. 2 illustrates a method 200 for implementing a reverse inclusion scheme in the processing system 100 of FIG. 1 in accordance with some embodiments. While the method 200 is described in the example context of a reverse inclusion scheme implemented between the L1 cache 108 and the L2 cache 110 of the cache hierarchy 102, the method 200 may similarly be applied for a reverse inclusion scheme implemented between the L2 cache 110 and the L3 cache 112, between the L1 cache 108 and the L3 cache 112, or between caches of other cache hierarchies. At block 202, the processing system 100 triggers a cache line eviction of the L2 cache 110. For example, following a cache miss, the processing system 100 triggers a cache line eviction to make room for the new cache line entry. For example, if processing core 114 attempts to fetch a cache line from the L2 cache 110, but the cache line does not reside in the L2 cache 110, then the processing system 100 may fetch the cache line from the L3 cache 112 or from system memory 106 and add the cache line to the L2 cache 110. However, if the L2 cache 110 is full, the processing system 100 must evict a resident cache line from the L2 cache 110 to make room for the new cache line, which in turn triggers the cache line eviction from the L2 cache 110.

At block 204, the cache controller 122 identifies one or more candidate cache lines for eviction from the L2 cache 110. The replacement policy logic 124 may identify a single candidate cache line or a set of candidate cache lines for eviction from the L2 cache based on the replacement policy. For example, in an embodiment employing an LRU replacement policy, the replacement policy logic 124 may identify a candidate cache line as the least recently used cache line of those residing in the L2 cache 110 or a set of candidate cache lines as a set of cache lines that are less recently used than the other cache lines residing in the L2 cache 110. For example, a set of three candidate cache lines identified using an LRU replacement policy would include the least recently used cache line, the second least recently used cache line, and the third least recently used cache line. The processing system 100 may determine how many cache lines to include in a set of candidate cache lines in any of a variety of methods, for example, the amount may be predetermined, programmable, determined based on the replacement policy, determined based on the number of cache lines in the L1 cache 108, a combination of these, and the like.

At decision block 206, the cache controller 122 determines for each candidate cache line of the set, whether a copy of the candidate cache line also resides in the L1 cache 108 using the residency storage module 128. To this end, the residency storage module 128 stores residency metadata indicating whether or not each cache line residing in the L2 cache 110 also resides in the L1 cache 108. For example, the residency metadata may be represented by an array of bits, each bit associated with a corresponding cache line of the L2 cache 110 and programmable to indicate whether the corresponding cache line resides in the L1 cache 108. In some embodiments, the residency storage module 128 comprises the tag array of the cache, such that, for a given cache line, the residency metadata (such as the array of bits) is stored in a corresponding tag entry of the cache line. In order to maintain the residency metadata, the cache controller 122 monitors the cache lines of the L1 cache 108 and the L2 cache 110, and sets or clears the bits of the residency metadata accordingly. For example, whenever a cache line is added to the L2 cache 110 that also resides in the L1 cache 108, or a cache line is added to the L1 cache 108 that already resides in the L2 cache 110, the corresponding bit of the residency metadata is set. Further, whenever a cache line is removed from the L1 cache 108 that still resides in the L2 cache 110, the corresponding bit of the residency metadata is cleared.

If the residency metadata indicates that the candidate cache line of the L2 cache 110 does reside in the L1 cache 108, at block 208 the replacement policy logic 124 identifies the candidate cache line as an invalid candidate for eviction. Alternatively, if at decision block 206 the residency metadata indicates that the candidate cache line of the L2 cache 110 does not reside in the L1 cache 108, at block 210 the replacement policy logic 124 identifies the candidate cache line as a valid candidate for eviction. Since the candidate cache line does not reside in the L1 cache 108, evicting the valid candidate cache line will not result in unnecessary invalidations of the L1 cache 108.

Following the identification of a candidate cache line as an invalid or valid candidate for eviction at blocks 208, 210, the cache controller 122 identifies, at decision block 212, whether there are any remaining candidate cache lines in the set. In the case that there are remaining candidate cache lines, the method 200 returns to block 206 to perform the validity determination for a subsequent candidate cache line of the set of candidate cache lines for eviction from the L2 cache 110. In some embodiments, the processing system 100 performs the validity determination for each candidate cache line of the set until the cache controller 122 identifies a valid candidate for eviction from the L2 cache 110, such that the processing system 100 only identifies a single valid candidate cache line for eviction. In other embodiments, the processing system 100 may perform the validity determination on the set of, or a subset of the set of candidate cache lines concurrently.

After completing the validity determination for each of the candidate cache lines of the set, such that at decision block 212 the cache controller 122 identifies that there are no more remaining candidate cache lines of the set, at block 214, the replacement policy logic 124 selects from the valid candidate cache lines a cache line to be evicted from the L2 cache 110 in response to the eviction trigger, while preventing selection of any invalid cache lines. The replacement policy logic 124 may select the cache line of the valid candidates to be evicted from the L2 cache using any of a variety of techniques. For example, in some embodiments, the replacement policy logic 124 selects the cache from the valid candidates based on the replacement policy. That is, for an LRU replacement policy, the least recently used candidate is selected to be evicted from the L2 cache 110 if a valid candidate, and if not, the second least recently used candidate is selected if a valid candidate, and so forth. In other embodiments, the replacement policy logic 124 may select the cache line from the valid candidates based on efficiency, the type of data in the cache line, a different replacement policy, a combination of these, and the like.

The cache controller 122 prevents eviction of the invalid candidate cache line so as to avoid unnecessary invalidations of the L1 cache 108 while still maintaining the inclusiveness property of the L2 cache 110. To illustrate, if the processing system 100 were to evict the invalid candidate cache line from the L2 cache 110, the processing system 100 would also have to evict the copy of the same cache line from the L1 cache 108 to maintain the inclusion property of the L2 cache 110 since the inclusive scheme requires all of the cache lines residing in the L1 cache 108 to also reside in the L2 cache 110. This eviction of an invalid candidate cache line from the L1 cache 108 would represent an unnecessary invalidation of the L1 cache 108 since the eviction was not necessary to make room for a new entry in the L1 cache 108 and did not evict the cache line based on a prediction that the cache line was the least likely to be used by the processing cores 114, 115 in the future. The processing system 100 may prevent eviction of the invalid candidate actively (e.g., marking the invalid candidate cache line to indicate that it is not to be evicted), passively as a result of another action (e.g., choosing a different cache line to evict), a combination of these, and the like.

With a valid cache line selected, at block 216, the processing system 100 evicts the selected cache line from the L2 cache 110 to make room for a new cache entry in the L2 cache 110. The cache controller 122 may move the evicted cache line into a lower cache, for example the L3 cache 112, or to the system memory 106 if the cache hierarchy 102 implements a write-back policy. Because the cache hierarchy 102 only evicts valid candidates (that is, cache lines without copies in the L1 cache 108) from the L2 cache 110, the cache hierarchy 102 is able to respond to an eviction trigger of the L2 cache 110 in a manner that avoids unnecessary invalidations of the L1 cache 108 that would result from evicting a cache line in the L1 cache 108 solely because it was evicted from the inclusive L2 cache 110, while still maintaining the inclusion property of the L2 cache 110.

In some embodiments, the cache controller 122 may not produce any valid candidates for eviction from the L2 cache 110. For example, if all of the cache lines residing in the L2 cache 110 also reside in the L1 cache 108, then all of the candidate cache lines would be considered invalid candidates. Similarly, in some embodiments there may be cache lines residing in the L2 cache 110 that do not reside in the L1 cache 108, but the set of candidate cache lines chosen by the replacement policy logic 124 may all also reside in the L1 cache 108, such that they are all invalid candidates. As such, some implementations of the method 200 may include further steps for the replacement policy logic 124 to choose a cache line for eviction when all of the candidate cache lines have been identified as invalid. For example, in some embodiments, the replacement policy logic 124 makes an exception and evicts an invalid candidate cache line in the unique instances when no valid candidate cache lines are available. In other embodiments, the replacement policy logic 124 prevents eviction of the invalid candidate cache line in response to a predetermined number N of eviction triggers, before making an exception upon the N+1th eviction trigger, and allowing the invalid cache line to be evicted from the L2 cache 110. Further, in other embodiments, the replacement policy logic 124 may select a second set of candidate cache lines for eviction based on a different replacement policy or different selection process in an effort to identify a valid candidate.

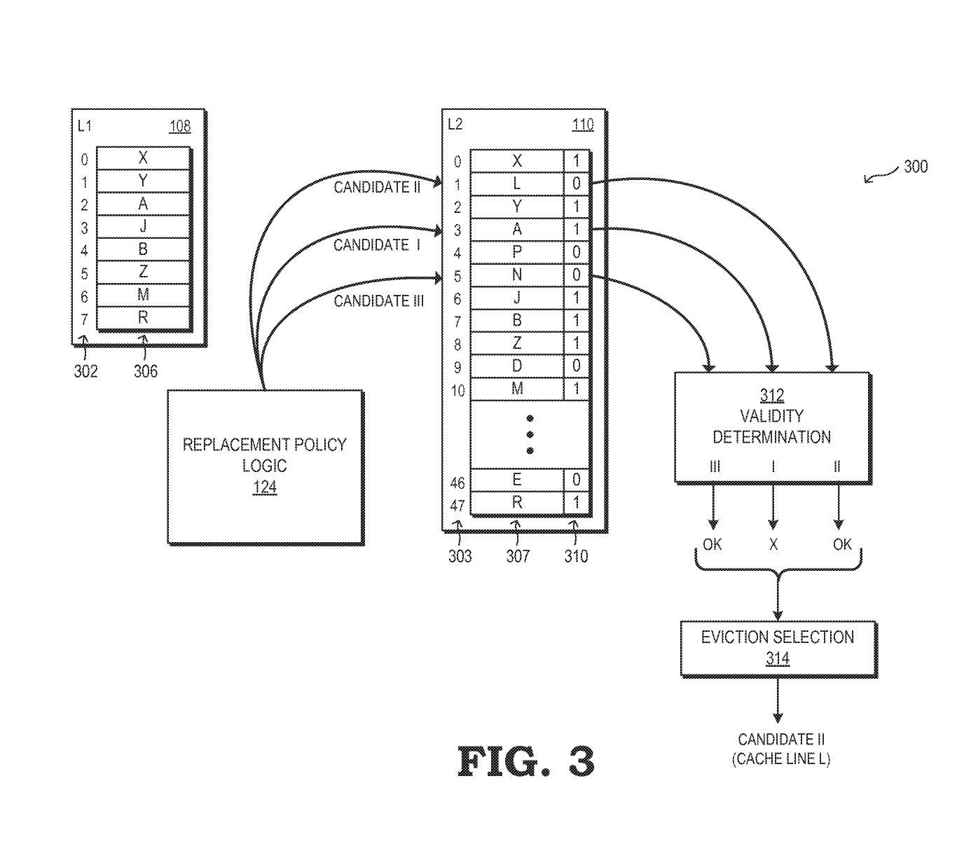

FIG. 3 illustrates an example operation 300 of the method 200 of FIG. 2 applied to the cache hierarchy 102 of FIG. 1 in accordance with some embodiments. The L1 cache 108 is depicted as comprising cache entries 302 for storing a plurality of cache lines 306. Similarly, the L2 cache 110 is depicted as comprising cache entries 303 for storing a plurality of cache lines 307. In some embodiments the L2 cache 110 is larger than the L1 cache 108, therefore the L2 cache 110 in these embodiments contains more cache entries 303 (than the L1 cache 108 having cache entries 302), such that more cache lines 307 can reside in the L2 cache 110 than in the L1 cache 108 (having cache lines 306). While the illustrated embodiment depicts the L1 cache 108 as having eight (numbered 0-7) cache entries 302 and the L2 cache 110 as having forty-eight (numbered 0-47) cache entries 303, the caches 108, 110 of other embodiments may be of any size and may contain any number of cache entries 302, 303. The L2 cache 110 is depicted as an inclusive cache such that the plurality of cache lines 306 residing in the L1 cache 108 (labeled, “X, Y, A, J, B, Z, M, R”) also reside in the L2 cache 110. While the L2 cache 110 is an inclusive cache, since it is larger than the L1 cache 108, it may store additional cache lines (labeled, “L, P, N, D, E”) as well, such that the plurality of cache lines 307 stored in the cache entries 303 of the L2 cache 110 both the cache lines (labeled, “X, Y, A, J, B, Z, M, R”) from the L1 cache 108 and the additional cache lines (labeled, “L, P, N, D, E”) that do not reside in the L1 cache 108.

For each of the cache lines 307 of the L2 cache 110, residency metadata 310 is stored by the residency storage module 128 to indicate whether the cache line also resides in the L1 cache 108. In some embodiments, the residency storage module 128 comprises the tag array of the cache, such that, for a given cache line, the residency metadata (such as the array of bits) is stored in a corresponding tag entry of the cache line. In the illustrated embodiment, the residency metadata 310 is depicted as an array of bits, each bit associated with a corresponding cache line 307 of the L2 cache 110 and programmable to indicate whether the corresponding cache line 307 resides in the L1 cache 108. Those bits of the residency metadata 310 with a value of “1” (or a logical value of true) indicate that the corresponding cache line of the L2 cache lines 307 also resides in the L1 cache 108, while those bits with a value of “0” (or a logical value of false) indicate that the corresponding cache line of the L2 cache lines 307 does not reside in the L1 cache 108. The cache controller 122 maintains the residency metadata 310 by monitoring the cache lines 306, 307 of the L1 cache 108 and the L2 cache 110, respectively. For example, the cache controller 122 sets a corresponding bit of the residency metadata anytime a cache line is added to the L2 cache 110 that also resides in the L1 cache 108, or a cache line is added to the L1 cache 108 that already resides in the L2 cache 110. Accordingly, anytime a cache line (that has a copy residing in the L2 cache 110) is evicted from the L1 cache 108, the cache controller 122 clears the bit of the residency metadata 310 corresponding to the copy of the cache line residing in the L2 cache 110.

In response to an eviction trigger, the replacement policy logic 124 identifies candidate cache lines for eviction from the L2 cache 110 based on one or more replacement policies. In the illustrated example operation 300, the replacement policy logic 124 identifies cache line “A” as a first candidate (candidate I), cache line “L” as a second candidate (candidate II), and cache line “N” as a third candidate (candidate III) based on the replacement policy. For example, if an LRU replacement policy is used, in this example the least recently used cache line (cache line “A”) of the plurality of cache lines 307 is the first candidate cache line (candidate I), the second least recently used cache line (cache line “L”) of the plurality of cache lines 307 is the second candidate cache line (candidate II), and the third least recently used cache lines (cache line “N”) of the plurality of cache line 307 is the third candidate cache line (candidate III). In different embodiments, the replacement policy logic 124 may identify more candidate cache lines or less candidate cache lines than the depicted embodiment.

For each candidate cache line I, II, III, the replacement policy logic 124 performs a validity determination 312 based on the residency metadata 310. The validity determination 312 comprises identifying those candidate cache lines I, II, III that also reside in the L1 cache 308 as invalid candidates and those candidate cache lines, I, II, III that do not reside in the L1 cache 308 as valid candidates. For example, the first candidate, cache line “A” has a corresponding residency metadata 310 value of “1” indicating that cache line “A” also resides in the L1 cache 108, and as such the validity determination 312 identifies cache line “A” as an invalid candidate for eviction from the L2 cache 110, as represented by the “X” symbol in the illustrated embodiment. The second candidate, cache line “L” has a residency metadata 310 value of “0” indicating that cache line “L” does not reside in the L1 cache 108, and as such the validity determination 312 identifies cache line “L” as a valid candidate for eviction from the L2 cache 110, as represented by the “OK” symbol in the illustrated embodiment. Similarly, the third candidate, cache line “N” has a residency metadata 310 value of “0” indicating that cache line “N” does not reside in the L1 cache 108, and as such the validity determination 312 identifies cache line “N” as a valid candidate for eviction from the L2 cache 110, as represented by the “OK” symbol in the illustrated embodiment.

The replacement policy logic 124 then performs an eviction selection 314, whereby a cache line is selected from the candidate cache lines (A, L, N) based on the validity determinations 312. Because an eviction of an invalid candidate, such as cache line “A”, would require the copy of cache line “A” to also be evicted from the L1 cache 108 to maintain the inclusion property, the replacement policy logic 124 prevents eviction of any invalid candidate cache lines (e.g., cache line “A”). As such, the eviction selection 314 comprises selecting the cache line from the valid candidate cache lines (L, N). In the illustrated embodiment, the ranking of the candidates I, II, III determined based on the replacement policy is used to select which of the valid candidates II, III should be evicted from the L2 cache 110. Since cache line “L” is the second candidate (candidate II), while cache line “N” is a lower ranked candidate (candidate III), cache line “L” (candidate II) is selected for eviction from the L2 cache 110. In the example context of an LRU replacement policy, the least recently used valid candidate is selected for eviction. Since the only valid candidates are cache line “L” and cache line “N”, and cache line “L” is the less recently used cache line, cache line “L” is chosen for eviction from the L2 cache 110. Since cache line “L” does not reside in the L1 cache 108, the eviction of cache line “L” avoids unnecessary invalidations of the L1 cache 108 while maintaining the inclusion property of the L2 cache 110.

While the illustrated embodiments are depicted as implementing a strict reverse inclusion scheme, whereby the cache controller 122 always prevents a cache line from being evicted from the L2 cache 110 if the cache line also resides in the L1 cache, other embodiments may provide a loose enforcement of the reverse inclusion scheme. For example, if all of the cache lines in the L2 cache 110 have respective copies in the L1 cache 108, then no candidate victim exists for which the eviction from the L2 cache 110 would not violate the reverse inclusion scheme. In a strict application of the reverse inclusion scheme no cache lines would be evicted, and therefore no cache lines could be added to the L2 cache 110. In a looser application, the best candidate cache line according to the replacement policy may be evicted despite the failure to enforce the reverse inclusion scheme. Further variations may exist where the failure to enforce the reverse inclusion scheme only occurs with a certain probability, or after the eviction has been prevented (due to the enforcement of the reverse inclusion scheme) a certain threshold number of times.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system comprising:
an inclusive cache hierarchy comprising a first cache and a second cache, wherein the inclusive cache hierarchy employs an inclusive scheme requiring that each cache line residing in the first cache also reside in the second cache; and
replacement policy logic to:
in response to an eviction trigger for the second cache:
identify a set of one or more candidate cache lines of the second cache for eviction;
for each cache line of the set, identify the candidate cache line as an invalid candidate cache line responsive to the candidate cache line residing in the first cache; and
prevent eviction of any invalid candidate cache lines of the set.

2. The system of claim 1, wherein the replacement policy logic further is to:
for each candidate cache line of the set, identify the candidate cache line as a valid candidate cache line responsive to the candidate cache line not residing in the first cache; and
select a valid candidate cache line of the set for eviction.

3. The system of claim 1, wherein the replacement policy logic further is to concurrently identify a validity of each candidate cache line of the set.

4. The system of claim 1, further comprising:
a residency storage module to store residency metadata identifying those cache lines of the second cache that also reside in the first cache; and
wherein the replacement policy logic is to identify which candidate cache lines of the set reside in the first cache based on the residency metadata.

5. The system of claim 4, wherein the residency storage module comprises an array of bits, each bit associated with a corresponding cache line of the second cache and programmable to indicate whether the corresponding cache line resides in the first cache.

6. The system of claim 4, wherein the residency storage module comprises a tag array of the second cache.

7. The system of claim 1, wherein the replacement policy logic identifies the set of one or more candidate cache lines based on a replacement policy including at least one of: least recently used (LRU), pseudo-LRU, not recently used (NRU), first in first out (FIFO), least frequently used (LFU), re-reference interval prediction (RRIP), random.

8. The system of claim 1, wherein the first cache comprises a higher level cache than the second cache.

9. A method comprising:
employing in a cache hierarchy of a processing system, an inclusive scheme requiring that each cache line residing in a first cache also reside in a second cache;
identifying a set of one or more candidate cache lines of the second cache for eviction;
for each candidate cache line of the set, identifying the candidate cache line as an invalid candidate cache line responsive to the candidate cache line residing in the first cache; and
preventing eviction of any invalid candidate cache lines of the set in response to an eviction trigger for the second cache.

10. The method of claim 9, further comprising:
for each candidate cache line of the set, identifying the candidate cache line as a valid candidate cache line responsive to the candidate cache line not residing in the first cache; and
selecting a valid candidate cache line of the set for eviction in response to the eviction trigger.

11. The method of claim 9, further comprising:
concurrently identifying a validity of each candidate cache line of the set.

12. The method of claim 9, further comprising:
maintaining residency metadata identifying those cache lines of the second cache that also reside in the first cache; and
wherein identifying which candidate cache lines of the set reside in the first cache comprises identifying candidate cache lines residing in the first cache based on the residency metadata.

13. The method of claim 12, wherein maintaining residency metadata further comprises maintaining residency metadata in a tag array of the second cache.

14. The method of claim 12, wherein the residency metadata comprises an array of bits, each bit associated with a corresponding cache line of the second cache and programmable to indicate whether the corresponding cache line of the second cache also resides in the first cache.

15. The method of claim 9, wherein identifying the set of one or more candidate cache lines based on a replacement policy including at least one of: least recently used (LRU), pseudo-LRU, not recently used (NRU), first in first out (FIFO), least frequently used (LFU), re-reference interval prediction (RRIP), random.

16. A non-transitory computer readable storage medium embodying a set of executable instructions, the set of executable instructions to manipulate at least one processor to:
employ an inclusive scheme requiring that each cache line residing in a first cache also reside in a second cache;
identify a set of one or more candidate cache lines of the second cache for eviction;
for each candidate cache line of the set, identify the candidate cache line as an invalid candidate cache line responsive to the candidate cache line residing in the first cache; and
prevent eviction of any invalid candidate cache lines of the set.

17. The non-transitory computer readable storage medium of claim 16, wherein the processor further is to:
for each candidate cache line of the set, identify the candidate cache line as a valid candidate cache line responsive to the candidate cache line not residing in the first cache; and
select a valid candidate cache line of the set for eviction.

18. The non-transitory computer readable storage medium of claim 16, wherein the processor further is to:
concurrently identify a validity of each candidate cache line of the set.

19. The non-transitory computer readable storage medium of claim 16, wherein the processor further is to:
maintain residency metadata identifying those cache lines of the second cache that also reside in the first cache; and
wherein the processor is to identify which candidate cache lines of the set reside in the first cache based on the residency metadata.

20. The non-transitory computer readable storage medium of claim 19, wherein the residency metadata comprises an array of bits, each bit associated with a corresponding cache line of the second cache and programmable to indicate whether the corresponding cache line resides in the first cache.
